(19) United States
(12) Patent Application Publication
(10) Pub. No.: US 2003/0031107 A1
(43) Pub. Date: Feb. 13, 2003

(54) Recording /reproduction apparatus, recording method, reproduction apparatus and distribution apparatus

(76) Inventors: Noriaki Horii, Osaka (JP); Masaya Yamamoto, Osaka (JP); Masatoshi Shimbo, Hyogo (JP)

Correspondence Address: Neil A. DuChez, Renner, Otto, Boisselle & Sklar, LLP, 1621 Euclid Avenue, Nineteenth Floor, Cleveland, OH, 44115, US

(21) Appl. No.: 10/214,435

(22) Filed: Aug. 7, 2002

(30) Foreign Application Priority Data
Aug. 9, 2001 (JP) 2001-242859

(51) Int. Cl. G11B 7/00; G06F 17/00; G06F 7/00

(52) U.S. Cl. 369/53.21; 707/104.1; 700/94; 705/52

(57) ABSTRACT

A recording/reproduction apparatus comprises a reading section for reading out audio contents and reproduction controlling information from audio information, a converting section for judging whether or not the reproduction controlling information can be set upon reproduction of the audio contents, wherein when the reproduction controlling information can be set, the converting section outputs the reproduction controlling information, while when the reproduction controlling information cannot be set, the converting section converts the reproduction controlling information to other reproduction controlling information which can be set and outputs the other reproduction controlling information, and a recording section for recording the audio contents and the other reproduction controlling information onto the recording medium when the converting section outputs the other reproduction controlling information.

### BACKGROUND OF THE INVENTION

1. Field of the Invention

The present invention relates to a recording/reproduction apparatus, a recording method, a reproduction apparatus, and a distribution apparatus. More particularly, the present invention relates to an apparatus for distributing audio contents and an apparatus for recording or reproducing distributed audio contents.

2. Description of the Related Art

Recently, the advent of Internet technologies has made it possible for users to use their personal computers (PCs) to download audio information which they like from web sites via the Internet and make payment by payment means, such as credit card. Such music distribution through electric commerce (EC) is becoming widespread. Audio information distributed through the Internet may contain reproduction controlling information. Reproduction controlling information indicates conditions under which audio information may be reproduced, such as the number of times reproduction can be repeated, and the expiration date after which reproduction is not permitted. If it is assumed that audio information is provided with reproduction controlling information containing Jun. 30, 2001 as the expiration date of reproduction, the user cannot reproduce the audio information after that date. There are a number of types of reproduction controlling information, varying depending on the web site or the audio information.

When the user downloads audio information with its reproduction controlling information to a recording/reproduction apparatus, the contents of the audio information may not be reproduced unless the recording/reproduction apparatus satisfies conditions presented by the reproduction controlling information. For example, when audio information containing reproduction controlling information representing the number of times reproduction can be repeated, the condition for reproduction cannot be set unless a recording/reproduction apparatus carries a function to count the number of reproductions. In this case, if the recording/reproduction apparatus cannot set the reproducing condition, audio contents cannot be reproduced.

Further, a recording/reproduction apparatus may be able to record reproduction controlling information as well as audio data onto a removable disk, such as a DVD-RAM. When the reproduction controlling information contained in the audio information can be set in the recording/reproduction apparatus, the recording/reproduction apparatus can reproduce audio information recorded on the removable disk.

It is desirable that audio information recorded on a removable disk can be reproduced by reproduction-only apparatuses, which have a large share on the music market, in addition to the recording/reproduction apparatus which has recorded the audio information onto the disk. In this case, if a reproduction apparatus cannot set reproducing conditions represented by reproduction controlling information contained in audio information, the reproduction apparatus cannot be used to reproduce the contents of audio data.

For example, when audio information provided with the number of times reproduction can be repeated, as reproduction controlling information, a reproduction apparatus has to have a function to rewrite the value of the number of times reproduction can be repeated (e.g., a function to record the number of times reproduction can be repeated onto a DVD-RAM so as to rewrite the value thereof). If not, audio information cannot be reproduced. In general, few reproduction apparatuses are able to rewrite a DVD-RAM.

Therefore, in order to make it possible for any reproduction apparatus to reproduce data which has been recorded by a recording/reproduction apparatus, reproduction controlling information contained in audio information is converted so that it can be reproduced by the recording/reproduction apparatus and other reproduction apparatuses, and the converted reproduction controlling information and the contents of the audio information are recorded onto a recording medium instead of the audio information provided with reproduction controlling information being directly recorded onto the recording medium by the recording/reproduction apparatus.

### SUMMARY OF THE INVENTION

According to one aspect of the present invention, a recording/reproduction apparatus comprises a reading section for reading out audio contents and reproduction controlling information for controlling the audio contents from audio information containing the audio contents and the reproduction controlling information, a converting section for judging whether or not the reproduction controlling information can be set upon reproduction of the audio contents, wherein when the reproduction controlling information can be set, the converting section outputs the reproduction controlling information, while when the reproduction controlling information cannot be set, the converting section converts the reproduction controlling information to other reproduction controlling information which can be set and outputs the other reproduction controlling information, and a recording section for recording the audio contents and the reproduction controlling information onto the recording medium when the converting section outputs the reproduction controlling information, or recording the audio contents and the other reproduction controlling information onto the recording medium when the converting section outputs the other reproduction controlling information.

In one embodiment of this invention, the converting section judges whether or not the reproduction controlling information can be set upon reproduction of the audio contents based on type information indicating a type of the reproduction controlling information which can be set.

In one embodiment of this invention, the audio information further contains conversion permission information indicating whether or not the reproduction controlling information is permitted to be converted to the other reproduction controlling information. The reading section further reads out the conversion permission information from the audio information. The recording/reproduction apparatus further comprises a judging section for judging based on the conversion permission information whether or not the reproduction controlling information can be converted to the other reproduction controlling information. The converting section converts the reproduction controlling information to the other reproduction controlling information when the judging section judges that conversion is possible and does not convert the reproduction controlling information to the other reproduction controlling information when the judging section judges that conversion is impossible.

In one embodiment of this invention, the audio information further contains conversion information for controlling conversion of the reproduction controlling information to the other reproduction controlling information. The reading section further reads out the conversion information from the audio information. The converting section converts the reproduction controlling information to the other reproduction controlling information based on the conversion information.

In one embodiment of this invention, the conversion information contains type information indicating a type of reproduction controlling information which can be set.

In one embodiment of this invention, the conversion information further contains designation information designating contents of the type information.

According to another aspect of the present invention, a recording method comprises a first step of reading out audio contents and reproduction controlling information for controlling the audio contents from audio information containing the audio contents and the reproduction controlling information, a second step of judging whether or not the reproduction controlling information can be set upon reproduction of the audio contents, wherein when the reproduction controlling information can be set, the reproduction controlling information is output, while when the reproduction controlling information cannot be set, the reproduction controlling information is converted to other reproduction controlling information which can be set and the other reproduction controlling information is output, and a third step of recording the audio contents and the reproduction controlling information onto the recording medium when the reproduction controlling information is output in the second step, or recording the audio contents and the other reproduction controlling information onto the recording medium when the other reproduction controlling information is output in the second step.

According to another aspect of the present invention, a distribution apparatus comprises a database storing a plurality of audio contents, and an output section for outputting audio information containing at least one of the plurality of audio contents. The audio information further contains reproduction controlling information for controlling the at least one of the plurality of audio contents, and conversion permission information indicating whether or not the reproduction controlling information is permitted to be converted to other reproduction controlling information.

According to another aspect of the present invention, a distribution apparatus comprises a database storing a plurality of audio contents, and an output section for outputting audio information containing at least one of the plurality of audio contents. The audio information further contains reproduction controlling information for controlling the at least one of the plurality of audio contents, and conversion information for controlling conversion of the reproduction controlling information to other reproduction controlling information.

In one embodiment of this invention, the conversion information contains type information indicating a type of reproduction controlling information which can be set.

In one embodiment of this invention, the conversion information further contains designation information designating contents of the type information.

According to another aspect of the present invention, a reproduction apparatus comprises a reading section for reading out audio contents and reproduction controlling information for controlling the audio contents from audio information containing the audio contents and the reproduction controlling information, a judging section for judging whether or not the audio contents can be reproduced, and a reproduction section for reproducing the audio contents when a result of judgment by the judging section indicates that reproduction is possible, or not reproducing the audio contents when a result of judgment by the judging section indicates that reproduction is impossible. The judging section judges whether or not the reproduction controlling information can be set upon reproduction of the audio contents. When the reproduction controlling information can be set, the judging section judges whether or not the audio contents can be reproduced based on the reproduction controlling information. When the reproduction controlling information cannot be set, the judging section converts the reproduction controlling information to other reproduction controlling information which can be set, and judges whether or not the audio contents can be reproduced based on the other, reproduction controlling information.

In one embodiment of this invention, the judging section converts the reproduction controlling information to the other reproduction controlling information based on conversion information for controlling conversion of the reproduction controlling information to the other reproduction controlling information.

According to another aspect of the present invention, a recording/reproduction apparatus comprises a reading section for reading out audio contents and permission information indicating a recording medium onto which the audio contents are permitted to be recorded, from audio information containing the audio contents and the permission information, a judging section for judging whether or not the audio contents can be recorded onto a recording medium based on the permission information, and a recording section for recording the audio contents onto the recording medium when the judging section judges that recording is possible, and not recording the audio contents onto the recording medium when the judging section judges that recording is impossible.

According to another aspect of the present invention, a distribution apparatus comprises a database storing a plurality of audio contents, and an output section for outputting audio information containing at least one of the plurality of audio contents. The audio information further contains permission information indicating a recording medium onto which the at least one of the plurality of audio contents is permitted to be recorded.

According to another aspect of the present invention, a distribution apparatus comprises a database storing a plurality of audio contents, and an output section for outputting a plurality of types of reproduction controlling information for controlling at least one of the plurality of audio contents. The output section outputs audio information containing the at least one of the plurality of audio contents and at least one piece of the plurality of types of reproduction controlling information selected by the user.

In one embodiment of this invention, a bill for the audio information output by the output section is changed based on the at least one reproduction controlling information selected by the user.

Thus, the invention described herein makes possible the advantages of providing a recording/reproduction apparatus, recording method, and reproduction apparatus for converting reproduction controlling information which cannot be set in a recording/reproduction apparatus and a reproduction apparatus to other reproduction controlling information which can be set in the recording/reproduction apparatus and the reproduction apparatus; a distribution apparatus for distributing information on conversion and a recording medium.

These and other advantages of the present invention will become apparent to those skilled in the art upon reading and understanding the following detailed description with reference to the accompanying figures.

### BRIEF DESCRIPTION OF THE DRAWINGS

FIG. 1 is a diagram showing a recording/reproduction apparatus according to Example 1 of the present invention.

FIG. 2 is a diagram showing a reproduction controlling information converting section in Example 1.

FIG. 3 is a diagram showing a distribution apparatus according to Example 2 of the present invention.

FIG. 4 is a diagram showing another distribution apparatus according to Example 2 of the present invention.

FIG. 5 is a diagram showing a recording/reproduction apparatus according to Example 2 of the present invention.

FIG. 6 is a diagram showing a reproduction controlling information converting section in Example 2.

FIG. 7 is a diagram showing another reproduction controlling information converting section in Example 2.

FIG. 8 is a diagram showing a reproduction apparatus according to Example 3 of the present invention.

FIG. 9 is a diagram showing a reproduction controlling information converting section in Example 3.

FIG. 10 is a diagram showing a distribution apparatus according to Example 4 of the present invention.

FIG. 11 is a diagram showing a recording/reproduction apparatus according to Example 4 of the present invention.

FIG. 12 is a diagram showing a distribution apparatus according to Example 5 of the present invention.

FIG. 13 is a diagram showing another distribution apparatus according to Example 5 of the present invention.

### DESCRIPTION OF THE PREFERRED EMBODIMENTS

Hereinafter, the present invention will be described by way of illustrative examples with reference to the accompanying drawings.

As used herein, the contents of audio information refer to music information to be reproduced as a work of music, and are also simply referred to as audio contents. The audio contents are not limited to a work of music and may refer to sound information, such as speech and sound effects. The audio information contains one or a plurality of audio contents.

### EXAMPLE 1

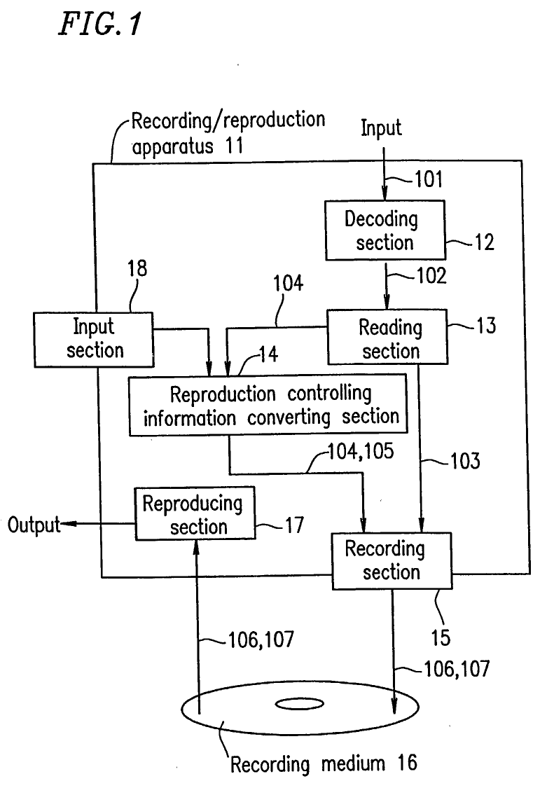

FIG. 1 shows a recording/reproduction apparatus 11 according to Example 1 of the present invention. The recording/reproduction apparatus 11 comprises a decoding section 12, a reading section 13, a reproduction controlling information converting section 14, a recording section 15, a reproducing section 17, and an input section 18.

The decoding section 12 decodes encrypted audio information 101 input to the recording/reproduction apparatus 11, and outputs the decoded audio information 102. The audio information 101 may be distributed from a distribution apparatus through a network, such as the Internet. The audio information 102 contains audio contents 103 and reproduction controlling information 104 for controlling reproduction of the audio contents 103. The reproduction controlling information 104 comprises type information for limiting reproduction and designation information for designating the contents of the type information. The type information indicates, for example, time during which reproduction can be performed, an expiration date after which reproduction cannot be performed, the number of times reproduction can be repeated, reproduction of part of audio contents, and reproduction with sound quality being controlled. The corresponding designation information indicates 15 minutes, Jun. 23, 2001, 3 times, a characteristic melody of a piece of music, and low quality. For example, the reproduction controlling information 104 indicates that the time during which reproduction can be performed is 15 minutes, and the expiration date after which reproduction cannot be performed is Jun. 23, 2001. The reading section 13 reads out the audio contents 103 and the reproduction controlling information 104 from the audio information 102.

The reproduction controlling information converting section 14 judges whether or not the reproduction controlling information 104 can be set when the audio contents 103 is to be reproduced. When judging that the reproduction controlling information 104 can be set, the reproduction controlling information converting section 14 outputs the reproduction controlling information 104. When judging that the reproduction controlling information 104 cannot be set, the reproduction controlling information converting section 14 converts the reproduction controlling information 104 to other reproduction controlling information 105 which can be set.

A recording medium 16 is placed in the recording/reproduction apparatus 11. When the reproduction controlling information converting section 14 outputs the reproduction controlling information 104, the recording section 15 produces audio information 106 containing the audio contents 103 and the reproduction controlling information 104 and records it onto the recording medium 16. When the reproduction controlling information converting section 14 outputs the other reproduction controlling information 105, the recording section 15 produces audio information 107 containing the audio contents 103 and the other reproduction controlling information 105 and records it onto the recording medium 16.

The reproducing section 17 reads out the audio information 106 or 107 from the recording medium 16, and performs reproduction in accordance with the reproduction controlling information 104 or 105. Note that the recording medium 16 may be loaded in and reproduced by a recording/reproduction apparatus or a reproduction apparatus other than the recording/reproduction apparatus 11.

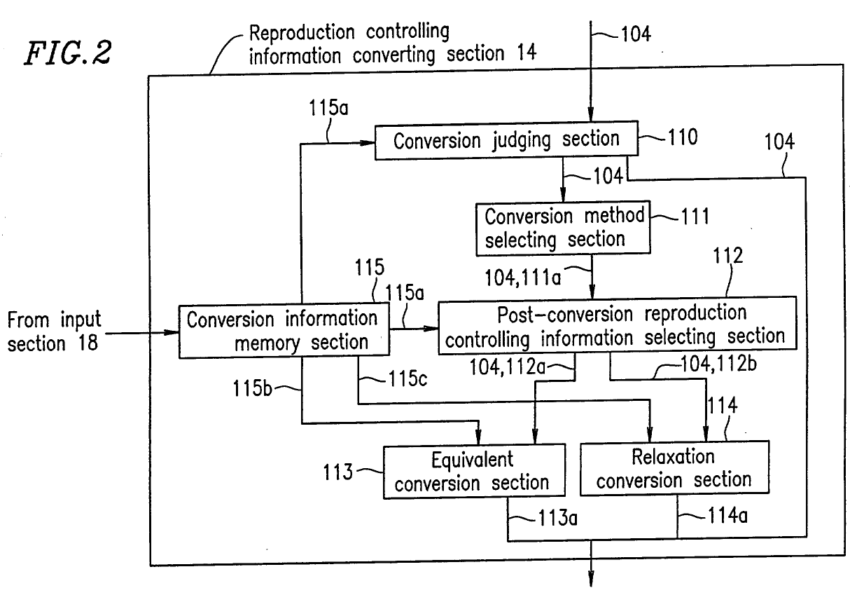

Referring to FIG. 2, operation of the reproduction controlling information converting section 14 will be described in more detail. The reproduction controlling information converting section 14 comprises a conversion judging section 110, a conversion method selecting section 111, a post-conversion reproduction controlling information selecting section 112, an equivalent conversion section 113, a relaxation conversion section 114, and a conversion information memory section 115.

The conversion information memory section 115 stores conversion information for controlling conversion of the reproduction controlling information 104 to the other reproduction controlling information 105. The conversion information includes, for example, type information indicating a type of reproduction controlling information which can be set by the recording/reproduction apparatus 11 when the audio contents 103 are to be reproduced, and conversion method information indicating a method for converting the reproduction controlling information 104 to the other reproduction controlling information 105.

The conversion judging section 110 judges whether or not reproduction controlling information 104 is of a type indicated by type information 115a stored in the conversion information memory section 115. As a result of the judgment, when the reproduction controlling information 104 corresponds to reproduction controlling information of a type indicated by the type information 115a, the conversion judging section 110 outputs the reproduction controlling information 104 as it is to the recording section 15. However, if the reproduction controlling information 104 does not correspond to the reproduction controlling information of the type indicated by the type information 115a, the conversion judging section 110 outputs the reproduction controlling information 104 to the conversion method selecting section 111.

When converting the reproduction controlling information 104 to the other reproduction controlling information 105, the conversion method selecting section 111 selects a method for converting a reproducing condition indicated by reproduction controlling information: equivalent conversion or relaxation conversion. The conversion method selecting section 111 outputs selection result information 111a and the reproduction controlling information 104 to the post-conversion reproduction controlling information selecting section 112. Note that the equivalent conversion is such that, for example, assuming that the audio contents 103 has a reproduction time length of 5 minutes, reproduction controlling information indicating that reproduction can be repeated three times is converted to that which indicates that reproduction can be continued for 15 minutes. Note that relaxation conversion is such that, for example, assuming the above-described situation, the reproduction controlling information is converted to that which indicates that reproduction can be performed for one week. In this case, since the audio contents 103 can be reproduced for one week, there is a possibility that the audio contents 103 are reproduced three times or more. As a result, the converted reproduction controlling information has a relaxed constraint.

The post-conversion reproduction controlling information selecting section 112 selects the type of the converted reproduction controlling information based on the selection result information 111a output from the conversion method selecting section 111 among the types of reproduction controlling information stored in the conversion information memory section 115. For example, when the reproduction controlling information 104 designates the number of times which reproduction is to be repeated, reproduction controlling information designating reproduction time length is designated in the case of equivalent conversion or reproduction controlling information designating time during which reproduction can be performed is designated in the case of relaxation conversion. After the selection, a type 112a of the selected reproduction controlling information and the reproduction controlling information 104 are output to the equivalent conversion section 113 in the case of equivalent conversion, or a type 112b of the selected reproduction controlling information and the reproduction controlling information 104 are output to the relaxation conversion section 114 in the case of relaxation conversion.

The equivalent conversion section 113 or the relaxation conversion section 114 reads out conversion method information 115b and 115c for reproduction controlling information from the conversion information memory section 115, and converts the reproduction controlling information 104 based on the conversion method information 115b and 115c to other reproduction controlling information 113a and 114a. The reproduction controlling information 113a and 114a are output as the reproduction controlling information 105 to the recording section 15.

Hereinafter, the case where the type information which the recording/reproduction apparatus 11 can set is the expiration date after which reproduction cannot be performed, and the type information indicated by the input reproduction controlling information 104 is the time during which reproduction can be performed will be described. For example, it is assumed that the time during which reproduction can be performed, indicated by the reproduction controlling information 104 is “60 hours” and the time when the audio information 101 was input is 5 pm, Jun. 20, 2001. After 60 hours, the time will be 5 am, Jun. 23, 2001. The time is rounded down by dropping the hour portion (5 hours) so that the time during which reproduction can be performed is converted to an expiration date after which reproduction cannot be performed, “Jun. 22, 2001”. The reproduction controlling information 105 indicating this resultant expiration date after which reproduction cannot be performed is output to the recording section 15.

Note that although the above-described conversion from the time during which reproduction can be performed to the expiration date after which reproduction cannot be performed is performed by dropping 5 hours, the expiration date after which reproduction cannot be performed may be “Jun. 23, 2001” by rounding up the time or “5 am, Jun. 23, 2001” without alternation.

Thus, by converting the type of reproduction controlling information to another type which can be set upon reproduction of audio contents, the recording/reproduction apparatus 11 can perform recording and reproduction even in a case where the recording/reproduction apparatus 11 cannot set a reproducing condition indicated by the reproduction controlling information 104.

Further, the type of reproduction controlling information which the user selects may be stored via the input section 18 into the conversion information memory section 115. The input section 18 comprises, for example, an input interface and a displaying section (not shown). A type of reproduction controlling information input by the user is, for example, a type of reproduction controlling information indicating a reproducing condition which can be set in the recording/reproduction apparatus 11, and a recording/reproduction apparatus and a reproduction apparatus possessed by the user. The user selects a desired type using an input interface from a list of the types of reproduction controlling information which is presented by the displaying section of the input section 18. Alternatively, the user may select an apparatus using an input interface from a list of the model names of recording/reproduction apparatuses and reproduction apparatuses presented by the input section 18. In this case, by storing information on each model and a type of reproduction controlling information which the model can set in a pair into the conversion information memory section 115, the reproduction controlling information converting section 14 can convert the reproduction controlling information 104 to a type of reproduction controlling information which a model which the user selects can set.

A conversion method may be input in a form, such as a program, through the input section 18 into an external apparatus, or a recording medium, such as CD, DVD and SD, using a LAN or the like. The input conversion method is stored in the conversion information memory section 115. The conversion method may be distributed from the source of audio information.

Reproduction controlling information recorded in the recording medium 16 is made to be of a type such that the recording/reproduction apparatus 11 and other recording/reproduction apparatuses and reproduction apparatuses possessed by the users can set the reproduction controlling information. Therefore, audio contents recorded in the recording medium 16 can be reproduced by a recording/reproduction apparatus and a reproduction apparatus possessed by the user.

Further, by providing the recording/reproduction apparatus 11 with the input section 18, it is possible to update type information and the conversion method stored in the conversion information memory section 115. Therefore, even when audio information distribution standard is updated, the recording/reproduction apparatus 11 can be adapted to comply with the distribution standard by updating the information stored in the conversion information memory section 115. Therefore, even when the distribution standard is updated, it is no longer necessary that the user purchases a new recording/reproduction apparatus.

Note that the type information includes the number of times reproduction can be repeated, reproduction of part of audio contents, reproduction with low sound quality in addition to the expiration date after which reproduction cannot be performed and the time during which reproduction can be performed. Reproduction controlling information may be converted among these reproducing conditions.

Note that audio information may be substituted for video information, and audio contents may be substituted for moving images.

Note that the recording medium 16 may be an optical disk, such as a DVD disk, and may also be a hard disk, a magnetic disk, a semiconductor memory, or the like.

Further, the recording/reproduction apparatus 11 may be a recording-only apparatus without the reproducing section 17.

Furthermore, the recording/reproduction apparatus 11 may not have the input section 18. In this case, the reproduction controlling information converting section 14 converts reproduction controlling information in accordance with type information and a conversion method previously stored in the conversion information memory section 115.

### EXAMPLE 2

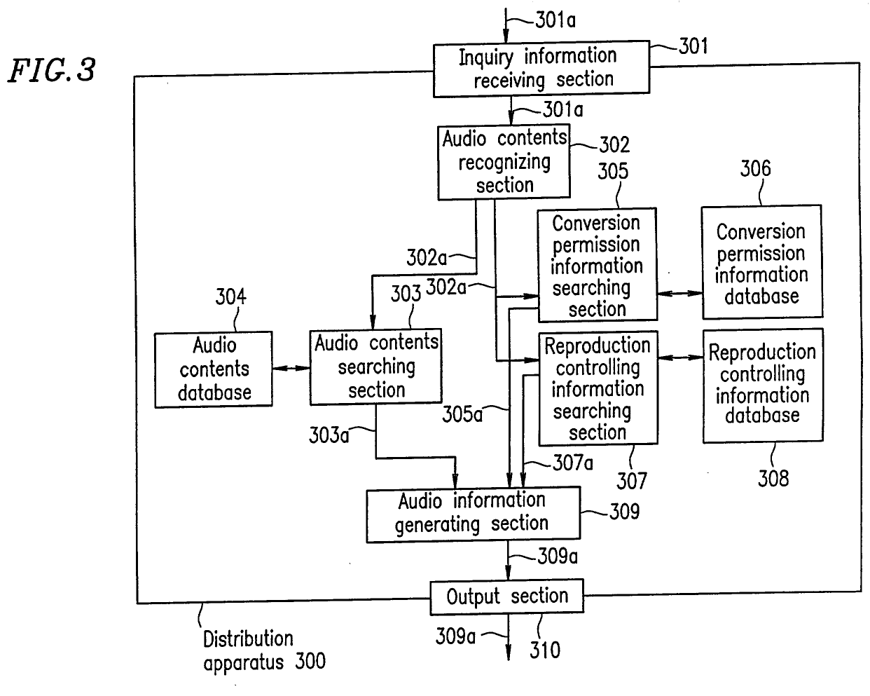

FIG. 3 shows a distribution apparatus 300 according to Example 2 of the present invention. The distribution apparatus 300 comprises an inquiry information receiving section 301, an audio contents recognizing section 302, an audio contents searching section 303, an audio contents database 304, a conversion permission information searching section 305, a conversion permission information database 306, a reproduction controlling information searching section 307, a reproduction controlling information database 308, an audio information generating section 309, and an output section 310.

Note that the audio contents database 304 stores a number of audio contents. In the audio contents database 304, audio contents and information for identifying the audio contents are stored in a pair. Examples of the audio contents identifying information include an ISRC code. The audio contents identifying information maybe any information which can be used to uniquely specify audio contents in a distribution apparatus, including, for example, text data containing the names of artists and the names of audio contents.

The reproduction controlling information database 308 stores information for identifying audio contents and reproduction controlling information given to the audio contents in a pair. The conversion permission information database 306 stores information for identifying audio contents and conversion permission information indicating whether or not reproduction controlling information given to the audio contents is permitted to be converted to other reproduction controlling information in a pair.

When receiving inquiry information 301a containing the user's request for downloading certain audio contents through the inquiry information receiving section 301, the distribution apparatus 300 outputs the received inquiry information 301a to the audio contents recognizing section 302. The audio contents recognizing section 302 stores information for identifying each audio content. The audio contents recognizing section 302 specifies information 302a for identifying audio contents to be distributed based on the inquiry information 301a, and outputs the identification information 302a to the audio contents searching section 303, the conversion permission information searching section 305, and the reproduction controlling information searching section 307. The audio contents searching section 303 searches the audio contents database 304 for audio contents 303a to be distributed based on the identification information 302a and outputs the audio. contents 303a to the audio information generating section 309. The reproduction controlling information searching section 307 searches the reproduction controlling information database 308 for reproduction controlling information 307a to be given to the audio contents 303a to be distributed based on the identification information 302a and outputs the reproduction controlling information 307a to the audio information generating section 309. The conversion permission information searching section 305 searches the conversion permission information database 306 for conversion permission information 305a relating to the reproduction controlling information 307a of the audio contents 303a to be distributed based on the identification information 302a and outputs the conversion permission information 305a to the audio information generating section 309.

The audio information generating section 309 generates audio information 309a containing the received audio contents 303a, conversion permission information 305a and reproduction controlling information 307a so that the audio information 309a complies with an audio information format, and outputs the audio information 309a to the output section 310 which in turn distributes the audio information 309a.

Note that the databases 304, 306 and 308 may be integrated into a single data base. In this case, the data base stores sets of audio contents identifying information, audio contents, reproduction controlling information and conversion permission information. With such a single database, each piece of data can be searched for simultaneously, so that the burden of searching is reduced. However, considering future extension, or update or maintenance of each piece of data, it may be more convenient that each piece of data is stored in a separate database.

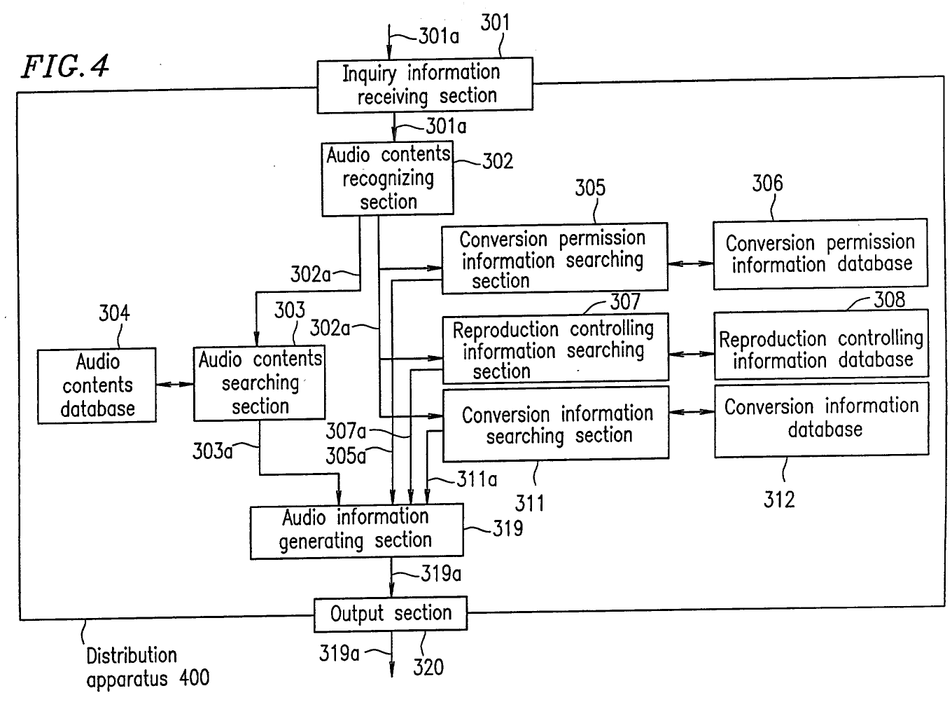

Next, a distribution apparatus 400 according to Example 2 of the present invention will be described with reference to FIG. 4. The distribution apparatus 400 comprises an inquiry information receiving section 301, an audio contents recognizing section 302, an audio contents searching section 303, an audio contents database 304, a conversion permission information searching section 305, a conversion permission information database 306, a reproduction controlling information searching section 307, a reproduction controlling information database 308, a conversion information searching section 311, a conversion information database 312, an audio information generating section 319, and an output section 320. The distribution apparatus 400 comprises, basically, the components of the distribution apparatus 300 and, in addition, the conversion information searching section 311 and the conversion information database 312.

The conversion information database 312 stores audio contents identifying information and conversion information corresponding to each audio content. The conversion information contains information for controlling conversion of reproduction controlling information to other reproduction controlling information. For example, the conversion information contains type information indicating a type of reproduction controlling information which can be set upon reproduction of each audio content, and designation information for designating the contents of the type information. When the type information indicates the number of times reproduction can be repeated, the designation information designates a specific number of times (e.g., 10 times).

In the distribution apparatus 400, the audio contents recognizing section 302 further outputs identification information 302a to the conversion information searching section 311.

The conversion information searching section 311 searches for conversion information 311a corresponding to audio contents 303a to be distributed based on the identification information 302a and outputs the conversion information 311a to the audio information generating section 319. Note that when conversion permission information 305a corresponding to the audio contents 303a indicates prohibition of conversion, no conversion information corresponding to the audio contents 303a may exist in the conversion information database.

The audio information generating section 319 generates audio information 319a containing the input audio contents 303a, the conversion permission information 305a, the reproduction controlling information 307a, and the conversion information 311a so that the audio information 319a complies with an audio information format, and outputs the audio information 319a to the output section 320 which in turn distributes the audio information 319a.

Note that the databases 304, 306, 308 and 312 may be integrated into a single database. In this case, the database stores sets of audio contents, audio contents identifying information, reproduction controlling information, conversion permission information, and conversion information. Note that in order not to store conversion information in a database when conversion permission information corresponding to certain audio contents indicates prohibition of conversion, it is preferable to integrate the conversion permission information database 306 and the conversion information database 312 into a single database. In this case, the same database stores sets of identification information, conversion permission information, and conversion information, and is refrained from storing conversion information on audio contents whose corresponding conversion permission information indicates prohibition of conversion.

Note that the conversion permission information searching section 305 and the conversion permission information database 306 maybe omitted from the distribution apparatus 400. In this case, the audio information generating section 319 generates audio information containing the audio contents 303a, the reproduction controlling information 307a and the conversion information 311a and outputs the audio information to the output section 320 which in turn distributes the audio information.

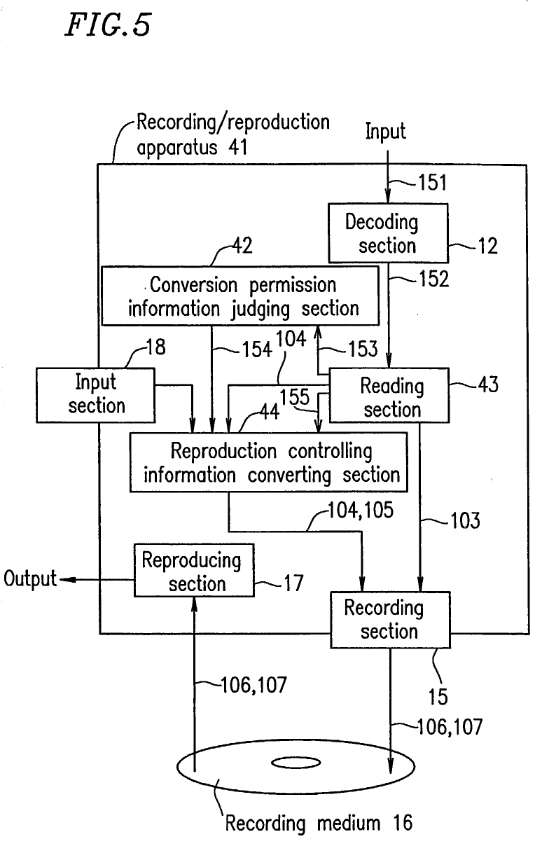

Next, a recording/reproduction apparatus 41 according to Example 2 of the present invention will be described with reference to FIG. 5. The recording/reproduction apparatus 41 comprises a decoding section 12, a conversion permission information judging section 42, a reading section 43, are production controlling information converting section 44, a recording section 15, a reproducing section 17, and an input section 18.

The decoding section 12 decodes encrypted audio information 151 input to the recording/reproduction apparatus 41, and outputs decoded audio information 152. The audio information 152 contains audio information 103, reproduction controlling information 104, conversion permission information 153, and the conversion information 155. The conversion permission information 153 indicates whether or not it is permitted to convert the reproduction controlling information 104 to other reproduction controlling information. The conversion information 155 contains information for controlling conversion of the reproduction controlling information 104 to the other reproduction controlling information. For example, the conversion information 155 contains type information indicating a type of reproduction controlling information which can be set upon reproduction of the audio contents 103, and designation information for designating the contents of the type information. The reading section 43 reads out the audio contents 103, the reproduction controlling information 104, the conversion permission information 153, and the conversion information 155 from the audio information 152.

When the conversion permission information 153 indicates permission of conversion of the reproduction controlling information 104 to other reproduction controlling information, the conversion permission information judging section 42 judges that conversion is possible. When the conversion permission information 153 indicates prohibition of conversion, the conversion permission information judging section 42 judges that conversion is impossible. The conversion permission information judging section 42 transmits a control signal 154 indicating a result of the judgment to the reproduction controlling information converting section 44.

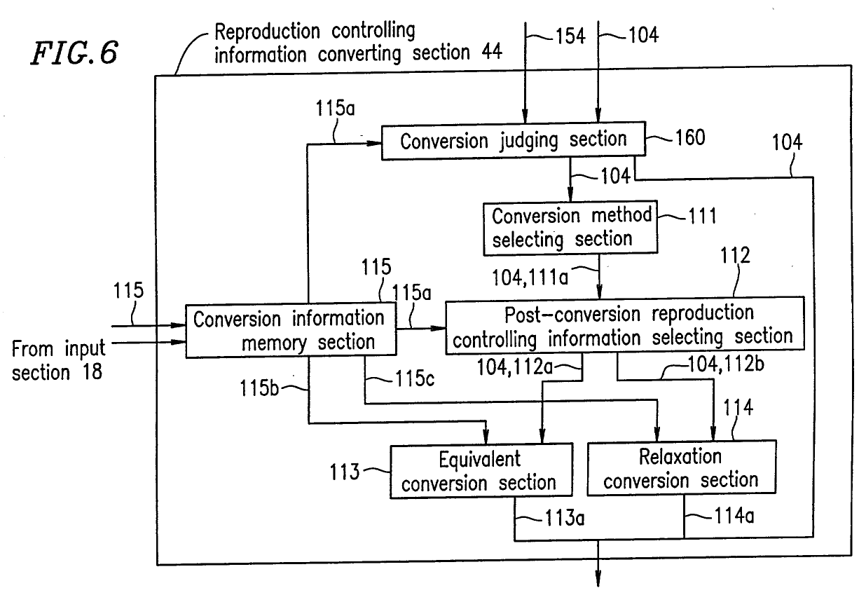

Referring to FIG. 6, the reproduction controlling information converting section 44 comprises a conversion judging section 160, a conversion method selecting section 111, a post-conversion reproduction controlling information selecting section 112, an equivalent conversion section 113, a relaxation conversion section 114, and a conversion information memory section 115.

The conversion judging section 160 judges whether or not the type information of the reproduction controlling information 104 matches the type information 115a previously stored in the conversion information memory section 115. As a result of the judgment, if the reproduction controlling information 104 corresponds to the type of a reproduction controlling information indicated by the type information 115a, the reproduction controlling information 104 is output to the recording section 15 without alteration. In this case, the recording section 15 generates audio information 106 containing the reproduction controlling information 104 and the audio contents 103 and records the audio information 106 onto the recording medium 16.

However, when the reproduction controlling information 104 corresponds to a type of reproduction controlling information indicted by the type information 115a, the conversion judging section 160 confirms the contents of the control signal 154. If the control signal 154 indicates permission of conversion, the conversion judging section 160 outputs the reproduction controlling information 104 to the conversion method selecting section 111. Conversion operations of the conversion method selecting section 111 and the subsequent stages are similar to those described in Example 1 with reference to FIG. 2. The recording section 15 generates and records the audio information 107 containing the reproduction controlling information 105 output by the reproduction controlling information converting section 44 and the audio contents 103 onto the recording medium 16.

Note that when the control signal 154 indicates prohibition of conversion, it is not permitted to convert and record the reproduction controlling information 104 onto the recording medium 16. In this case, the conversion judging section 160 outputs the reproduction controlling information 104 to the recording section 15 without alteration. The recording section 15 records the audio information 106 onto the recording medium 16, but the recording/reproduction apparatus 41 (or other information recording/reproduction apparatuses and reproduction apparatuses possessed by the user) cannot reproduce the audio contents 103.

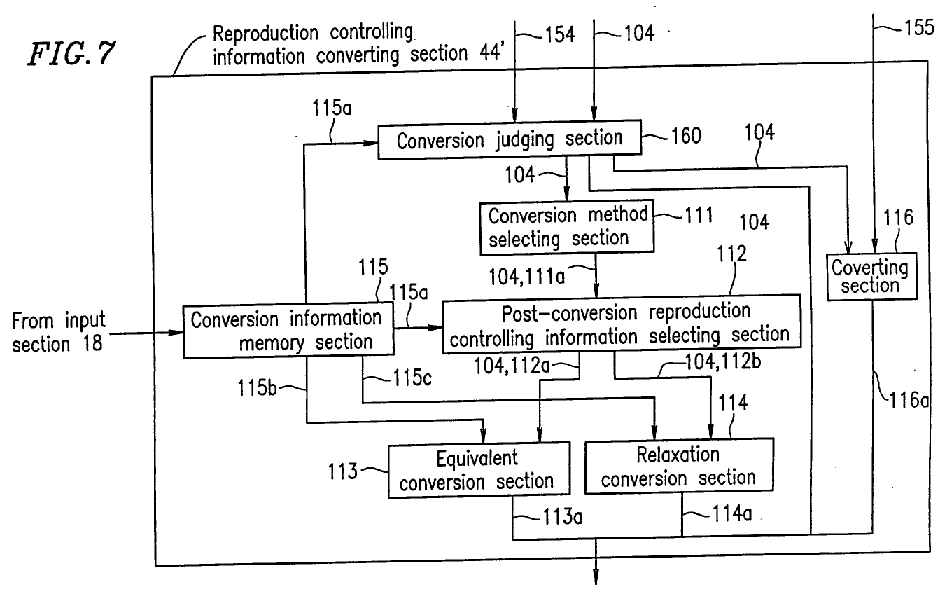

Note that a reproduction controlling information converting section 44′ as shown in FIG. 7 may be employed instead of the reproduction controlling information converting section 44. The reproduction controlling information converting section 44′ comprises a converting section 116 in addition to the components of the reproduction controlling information converting section 44. In the reproduction controlling information converting section 44′, if a type of reproduction controlling information indicated by the type information 115a does not correspond to the reproduction controlling information 104 and the control signal 154 indicates permission of conversion, the conversion judging section 160 outputs the reproduction controlling information 104 to the converting section 116. The converting section 116 converts the reproduction controlling information 104 to other reproduction controlling information 116a based on the conversion information 155. The reproduction controlling information 116a is output to the recording section 15 as reproduction controlling information 105.

Hereinafter, the case where type information which can be set by the recording/reproduction apparatus 41 is an expiration date after which reproduction cannot be performed and type information indicated by the input reproduction controlling information 104 is time during which reproduction can be performed, will be described (the same is true of the case where the recording/reproduction apparatus 41 can be set, the type information of reproduction controlling information contained the type information of the conversion information 155 is an expiration date after which reproduction cannot be performed, and type information indicated by the reproduction controlling information 104 is time during which reproduction can be performed). For example, it is assumed that the time during which reproduction can be performed, indicated by the reproduction controlling information 104, is “60 hours” and the time input by the audio information 151 is 5 pm, Jun. 20, 2001. In this case, as described in Example 1, reproduction controlling information 105 indicating “Jun. 22, 2001” is output as the expiration date after which reproduction cannot be performed is output to the recording section 15.

Hereinafter, the case where the conversion information 155 contains type information and designation information will be described. It is assumed that type information which can be set by the recording/reproduction apparatus 41 is the number of times reproduction can be repeated, and type information indicated by the reproduction controlling information 104 is time during which reproduction can be performed. For example, when the reproduction controlling information 104 indicates “1 hour” as the time during which reproduction can be performed, the conversion permission information 154 indicates that conversion is possible, and the designation information indicates “5 minutes of the time during which reproduction can be performed is equivalent to 1 time of the number of times reproduction can be repeated”, the reproduction controlling information converting section 44 converts “1 hour” as the time during which reproduction can be performed to reproduction controlling information indicating “12 times” as the number of times reproduction can be repeated.

Another case where the conversion information 155 contains type information and designation information will be described. It is assumed that type information which can be set by the recording/reproduction apparatus 41 is the number of times reproduction can be repeated, and type information indicated by the reproduction controlling information 104 is time during which reproduction can be performed. For example, when the reproduction controlling information 104 indicates “60 hours” as the time during which reproduction can be performed, the conversion permission information 154 indicates that conversion is possible, and the designation information indicates “the number of times reproduction can be repeated is set to be 10 times irrespective of the time during which reproduction can be performed”, the reproduction controlling information converting section 44 outputs reproduction controlling information indicating “10 times” as the number of times reproduction can be repeated.

As described above, by converting reproduction controlling information based on conversion permission information and conversion information (i.e., type information and designation information), it is possible to prevent the reproduction controlling information from being converted to other reproduction controlling information with disregard of the copyright of audio contents so as to unjustly reproduce audio contents.

Further, by selecting the type of reproduction controlling information after conversion from a plurality of types of reproduction controlling information, it is possible to employ a more number of recording/reproduction apparatuses and reproduction apparatuses to reproduce audio contents.

Furthermore, when the conversion information 155 contains designation information, reproduction controlling information indicated by the designation information is output without alteration. Therefore, it is not necessary that the reproduction controlling information converting section 44 understands reproduction controlling information piece by piece.

Note that audio information may be substituted for video information, and audio contents may be substituted for moving images.

Note that the recording/reproduction apparatus 41 may be a recording-only apparatus without the reproducing section 17. Alternatively, the input section 18 may be omitted from the recording/reproduction apparatus 11.

Further, the conversion permission information judging section 42 may be omitted from the recording/reproduction apparatus 11. In this case, the reproduction controlling information converting section 44 converts reproduction controlling information not based on the control signal 154.

Furthermore, when the audio information 152 does not contain conversion information, the reproduction controlling information converting section 44 converts reproduction controlling information based on type information and conversion method information previously stored in the conversion information memory section 115.

### EXAMPLE 3

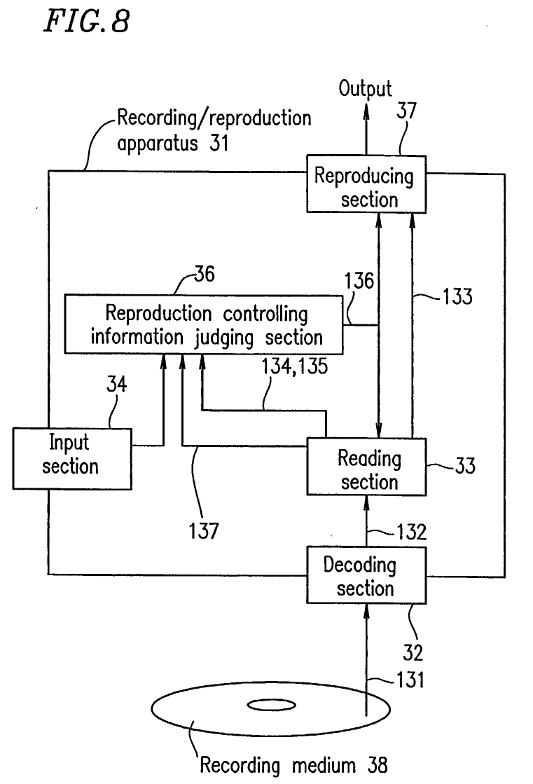

FIG. 8 shows a reproduction apparatus 31 according to Example 3 of the present invention. The reproduction apparatus 31 comprises a decoding section 32, a reading section 33, an input section 34 for receiving new conversion information, a reproduction controlling information judging section 36 for judging whether or not audio contents can be reproduced based on reproduction controlling information, and a reproducing section 37 for reproducing audio contents.

The decoding section 32 decodes encrypted audio information 131 read out from a recording medium 38, and outputs the decoded audio information 132. The audio information 132 contains audio contents 133, reproduction controlling information 134 and identification information 135. The reading section 33 reads out the audio contents 133, the reproduction controlling information 134 and the identification information 135 from the audio information 132. The reproduction controlling information judging section 36 judges whether or not the audio contents,133 can be reproduced based on the reproduction controlling information 134.

The reproduction controlling information judging section 36 judges whether or not the reproduction controlling information 134 can be set upon reproduction of the audio contents 133. When the reproduction controlling information 134 can be set, whether or not the audio contents 133 can be reproduced based on the reproduction controlling information 134 is judged. For example, when the type information of the reproduction controlling information 134 is a number of times reproduction can be repeated, if the number of times which the audio contents 133 has been reproduced is smaller than the number of times reproduction can be repeated indicated by the type information, it is judged that reproduction is possible. If the number of times which the audio contents 133 has been reproduced is greater than or equal to the number of times reproduction can be repeated, it is judged that reproduction is impossible. Further, when the reproduction controlling information 134 cannot be set, the reproduction controlling information judging section 36 converts the reproduction controlling information 134 to other reproduction controlling information which can be set, and judges whether or not the audio contents 133 can be reproduced based on the other reproduction controlling information. The reproduction controlling information judging section 36 outputs a control signal 136 indicating a result of the judgment to the reading section 33.

When the control signal 136 indicate that the audio contents 133 can be reproduced, the reading section 33 outputs the read audio contents 133 to the reproducing section 37, and the reproducing section 37 reproduce the audio contents 133. However, when the control signal 136 indicates that the audio contents 133 cannot be reproduced, the reading section 33 cancels reading of the audio contents 133, and the reproducing section 37 does not reproduce the audio contents 133. Note that the control signal 136 may be output to the reproducing section 37. In this case, when the control signal 136 indicates that reproduction is possible, the reproducing section 37 reproduces the audio contents 133, and when the control signal 136 indicates that reproduction is impossible, the reproducing section 37 does not reproduce the audio contents 133. Note that the control signal 136 maybe output to the encoding section 32. In this case, the reproduction apparatus 31 first reads out the reproduction controlling information 134 and the identification information 135 from the recording medium 38 and the reproduction controlling information judging section 36 judges whether or not audio contents identified by the identification information 135 can be reproduced. When it is judged as a result of the judgment that reproduction is possible, the control signal 136 indicating a result of the judgment is output to the decoding section 32 and the audio contents are read out from the recording medium 38.

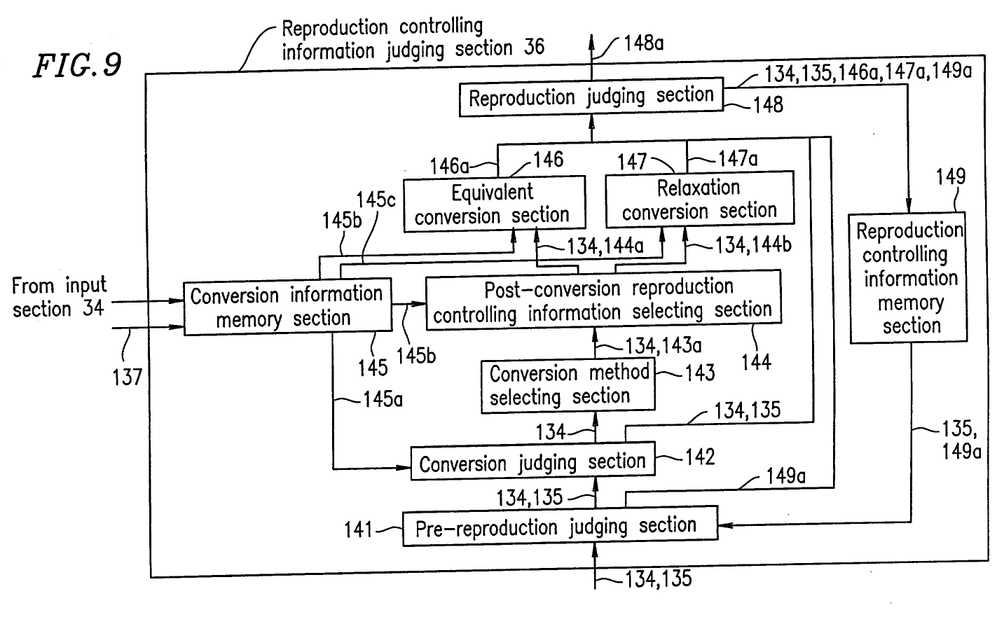

Further, for reproduction controlling information on the audio contents which has already been reproduced by the reproduction apparatus 31, the identification information and reproduction controlling information of the audio contents are stored in a pair to a reproduction controlling information memory section 149 (FIG. 9). When the same audio contents are reproduced at a second time and thereafter, reproduction is controlled in accordance with the reproduction controlling information stored in the memory.

An operation of the reproduction controlling information judging section 36 will be further described with reference to FIG. 9. The reproduction controlling information judging section 36 comprises a prereproduction judging section 141, a conversion judging section 142, a conversion method selecting section 143, a post-conversion reproduction controlling information selecting section 144, a conversion information memory section 145, an equivalent conversion section 146, a relaxation conversion section 147, a reproduction judging section 148, and a reproduction controlling information memory section 149.

The conversion information memory section 145 stores conversion information for controlling conversion of reproduction controlling information to other reproduction controlling information. The conversion information contains, for example, type information indicating a type of reproduction controlling information which can be set by the reproduction apparatus 11 upon reproduction of the audio contents 133, and designation information for designating the contents of the type information. Further, new conversion information may be stored through the input section 34 to the conversion information memory section 115. In this case, conversion method information may be input in a form, such as a program, through the input section 34 into an external apparatus, or a recording medium, such as CD, DVD and SD, using a LAN or the like. The input conversion method is stored in the conversion information memory section 115. Alternatively, the conversion information may be provided from the recording medium 38, and the conversion information 137 read by the reading section may be stored in the conversion information memory section 145. Further, identification information for audio contents which was reproduced in the past and its reproduction controlling information are stored in the reproduction controlling information memory section 149.

When the reproduction controlling information judging section 36 receives the reproduction controlling information 134 and the identification information 135, the prereproduction judging section 141 judges whether or not the identification information 135 is stored in the reproduction controlling information memory section 149. If a result of the judgment shows that the corresponding identification information 135 is stored, reproduction controlling information 149a corresponding to the identification information 135 stored in the reproduction controlling information memory section 149 is read out and output to the reproduction judging section 148. The reproduction judging section 148 judges based on the reproduction controlling information 149a whether or not the audio contents 133 can be reproduced. For example, when the type information of the reproduction controlling information 149a is a number of times reproduction can be repeated, if the number of times which the audio contents 133 has been repeated is smaller than or equal to the number of times reproduction can be repeated (i.e., the number of times reproduction can be repeated, indicated by the updated reproduction controlling information 149a, is greater than or equal to 1 as described below), it is judged that reproduction is possible. If the number of times which the audio contents 133 has been repeated is greater than the number of times reproduction can be repeated (i.e., the number of times reproduction can be repeated, indicated by the updated reproduction controlling information 149a, is zero), it is judged that reproduction is impossible. The reproduction judging section 148 outputs a control signal 148a indicating that reproduction is possible or impossible.

The reproduction judging section 148 updates the contents of the reproduction controlling information of the reproduction controlling information memory section 149 in response to reproduction of the audio contents 133. For example, when the reproduction controlling information that reproduction can be performed three times is stored in the reproduction controlling information memory section 149, if the audio contents 133 is reproduced one time, the reproduction controlling information that reproduction can be performed three times is updated to reproduction controlling information that reproduction can be performed two times.

On the other hand, when judging that the identification information 135 is not stored in the reproduction controlling information memory section 149, the prereproduction judging section 141 outputs the reproduction controlling information 134 and the identification information 135 to the conversion judging section 142. The conversion judging section 142 judges whether or not the reproduction controlling information 134 corresponds to reproduction controlling information indicated by type information 145a stored in the conversion information memory section 145. If a result of the judgment reveals that such correspondence is present, the reproduction controlling information 134 and the identification information 135 are output to the reproduction judging section 148. The reproduction judging section 148 judges based on the reproduction controlling information 134 whether or not the audio contents 133 can be reproduced, and outputs the control signal 148a. Further, the reproduction judging section 148 stores the reproduction controlling information 134 and the identification information 135 into the reproduction controlling information memory section 149, and updates the contents of the reproduction controlling information 134 in response to reproduction of the audio contents 133.

Further, when judging that the reproduction controlling information 134 does not correspond to reproduction controlling information indicated by the type information 145a, the conversion judging section 142 outputs the reproduction controlling information 134 to the conversion method selecting section 143. The subsequent operations of the reproduction controlling information judging section 36 are basically the same as the operations of the reproduction controlling information converting section 14 of Example 1.

When converting the reproduction controlling information 134 to other reproduction controlling information, the conversion method selecting section 143 selects equivalent conversion or relaxation conversion for the reproduction controlling information 134. The conversion method selecting section 143 outputs the selection result information 143a and the reproduction controlling information 134 to the post-conversion reproduction controlling information selecting section 144.

The post-conversion reproduction controlling information selecting section 144 selects the type of reproduction controlling information after conversion based on the selection result information 143a from the types of reproduction controlling information stored in the conversion information memory section 145. After the selection, when equivalent conversion is performed, the selected type 144a of reproduction controlling information and the reproduction controlling information 134 to the equivalent conversion section 146. When relaxation conversion is performed, the selected type 144b of reproduction controlling information and the reproduction controlling information 134 are output to the relaxation conversion section 147.

The equivalent conversion section 146 or the relaxation conversion section 147 read out conversion method information 145b and 145c indicating a method for converting reproduction controlling information to other reproduction controlling information from the conversion information memory section 115, and converts the reproduction controlling information 134 to other reproduction controlling information 146a and 147a based on the conversion method information 145b and 145c. The reproduction controlling information 146a and 147a are output to the reproduction judging section 148. Note that the conversion judging section 142 outputs the identification information 135 to the reproduction judging section 148.

The reproduction judging section 148 judges based on the reproduction controlling information 146a or 147a whether or not the audio contents 133 can be reproduced, and outputs the control signal 148a. Further, the reproduction judging section 148 stores the reproduction controlling information 146a or 147a and the identification information 135 into the reproduction controlling information memory section 149, and updates the contents of the stored reproduction controlling information 146a or 147a in response to the audio contents 133.

It is here assumed that type information which can be set by the reproduction apparatus 31 is a number of times reproduction can be repeated, and the reproduction controlling information 134 indicates time during which reproduction can be performed. In this case, the reproduction controlling information judging section 36 converts the reproduction controlling information 134 to reproduction controlling information indicating the number of times reproduction can be repeated. As a result, it is possible to judge whether or not the audio contents 133 can be reproduced based on the converted reproduction controlling information. Therefore, even when receiving audio contents associated with reproduction controlling information which cannot be set, the reproduction apparatus 31 can reproduce the audio contents.

Therefore, the reproduction apparatus 31 of the present invention can reproduce audio contents which cannot be conventionally reproduced when a reproducing condition for reproduction controlling information cannot be set.

Note that audio information may be substituted for video information, and audio contents may be substituted for moving images.

### EXAMPLE 4

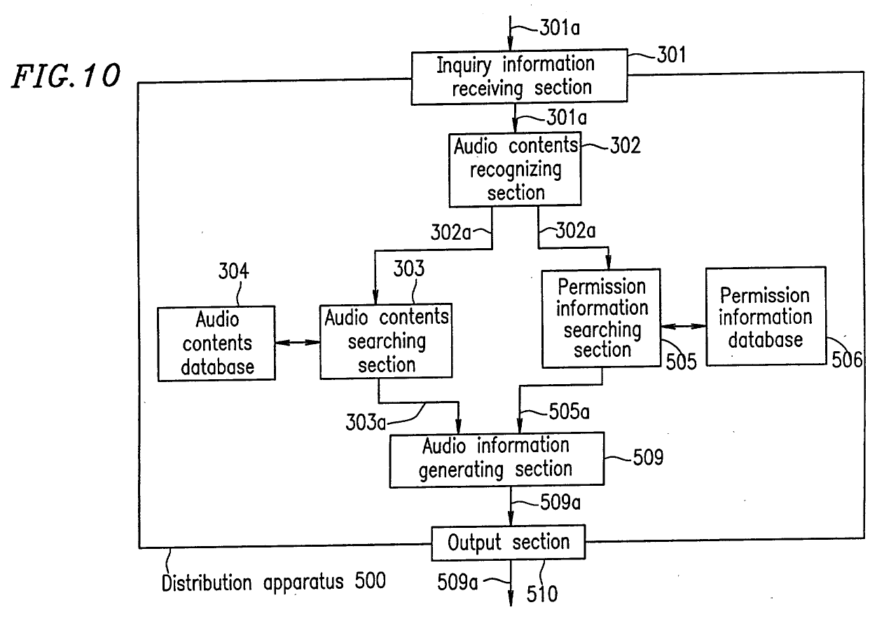

FIG. 10 shows a distribution apparatus 500 according to Example 4 of the present invention. The distribution apparatus 500 comprises an inquiry information receiving section 301, an audio contents recognizing section 302, an audio contents searching section 303, an audio contents database 304, a permission information searching section 505, a permission information database 506, an audio information generating section 509, and an output section 510.

The permission information database 506 stores identification information for audio contents and permission information given to the audio contents in a pair. The permission information indicates the type of a recording medium which is permitted to record the audio contents. For example, when the type of a recording medium indicated by the permission information is a DVD disk and a SD (Secure Digital) memory card, it is possible to record the audio contents to be distributed onto a DVD disk and a SD memory card, but not other recording media (e.g., CD-R).

When the distribution apparatus 500 receives inquiry information 301a requesting for download of audio contents from the user through the inquiry information receiving section 301, the distribution apparatus 500 outputs the received inquiry information 301a to the audio contents recognizing section 302. The audio contents recognizing section 302 specifies identification information 302a for audio contents to be distributed based on the inquiry information 301a, and outputs the identification information 302a to the audio contents searching section 303 and the permission information searching section 505. The audio contents searching section 303 searches the audio contents database 304 for audio contents 303a based on the identification information 302a and outputs the audio contents 303a to the audio information generating section 509. The permission information searching section 505 searches the permission information database 506 for permission information 505a relating to the audio contents 303a to be distributed based on the identification information 302a and outputs the permission information 505a to the audio information generating section 509.

The audio information generating section 509 generates audio information 509a containing the input audio contents 303a and the permission information 505a so that the audio information 509a complies with an audio information format, and outputs the audio information 509a to the output section 510 which in turn distributes the audio information 509a.

Note that the databases 304 and 506 may be integrated to a single database. In this case, the database stores sets of audio contents identifying information, audio contents, and permission information. With such a single database, each piece of data can be searched for simultaneously, so that the burden of searching is reduced. However, considering future extension, or update or maintenance of each piece of data, it may be more convenient that each piece of data is stored in a separate database.

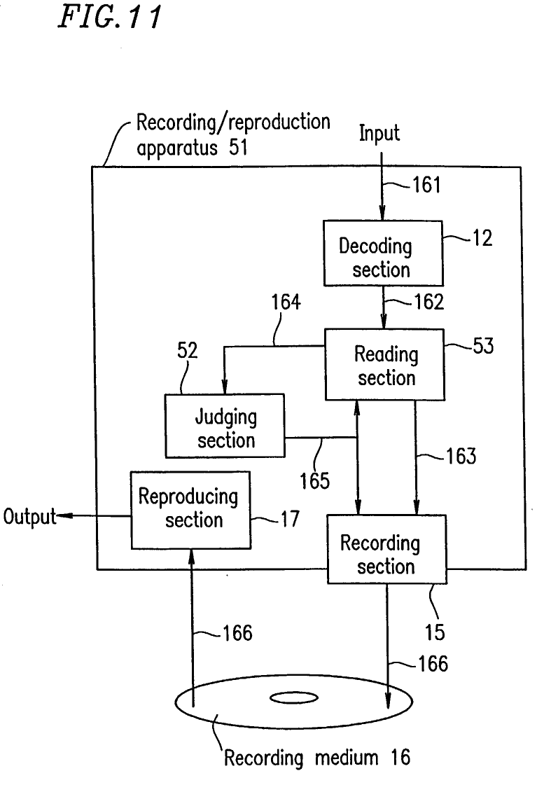

Next, a recording/reproduction apparatus 51 according to Example 4 of the present invention will be described with reference to FIG. 11. The recording/reproduction apparatus 51 comprises a decoding section 12, a judging section 52, a reading section 53, a recording section 15, and a reproducing section 17.

The decoding section 12 decodes encrypted audio information 161 input to the recording/reproduction apparatus 51 and outputs decoded audio information 162. The audio information 162 contains audio contents 163 and permission information 164 indicating the type of recording medium which is permitted to record audio contents. The reading section 53 reads out the audio contents 163 and the permission information 164 from the audio information 162.

The judging section 52 judges based on the permission information 164 whether or not the audio contents 163 can be recorded onto the recording medium 16, and outputs a control signal 165 indicating a result of the judgment to the reading section 53.

When the control signal 165 indicates that the audio contents 163 can be recorded, the reading section 53 outputs the read audio contents 163 to the recording section 15, and the recording section 15 generates and records audio information 166 containing the audio contents 163 onto the recording medium 16. However, when the control signal 165 indicates that the audio contents 163 cannot be recorded, the reading section 53 cancels the reading of the audio contents 163, and the recording section 15 does not record the audio information 166 onto the recording medium 16. Note that the control signal 165 may be output to the recording section 15. In this case, when the control signal 165 indicates that reproduction can be performed, the recording section 15 records the audio information 166 onto the recording medium 16. When the control signal 165 indicates that reproduction cannot be performed, the recording is not performed. The reproducing section 17 reads out the audio information 16 from the recording medium 16 and reproduces the audio contents 163.

When a plurality of types of recording media are loaded in the recording/reproduction apparatus 51, the judging section 52 may select a recording medium onto which data can be recorded by the recording/reproduction apparatus 51 from the recording media based on the permission information 164. The recording section 15 records the audio information 166 onto the selected recording medium. When no recording medium indicated by the permission information 164 is loaded in the recording/reproduction apparatus 51, the audio information 166 is not recorded.

The permission information 164 may indicate the type of an application. In this case, the audio information 166 can be recorded onto a recording medium onto which information designating reproduction of the audio contents 163 using an application indicated by the permission information 164 can be recorded. For example, it is assumed that the recording/reproduction apparatus 51 is provided with an application called SD jukebox, and the permission information 164 indicates SD jukebox. In this case, the audio information 166 can be recorded onto a recording medium onto which information designating reproduction of the audio contents 163 using SD jukebox can be recorded.

By selecting recording media as described above, it is possible to prevent the user from recording audio contents onto a recording medium which has no copyright protection function, against the intention of the copyright holder and without permission, so that unjust reproduction and copying of audio contents can be avoided.

Note that audio information may be substituted for video information, and audio contents may be substituted for moving images.

Further, the recording/reproduction apparatus 51 may be a recording-only apparatus without the reproducing section 17.

### EXAMPLE 5

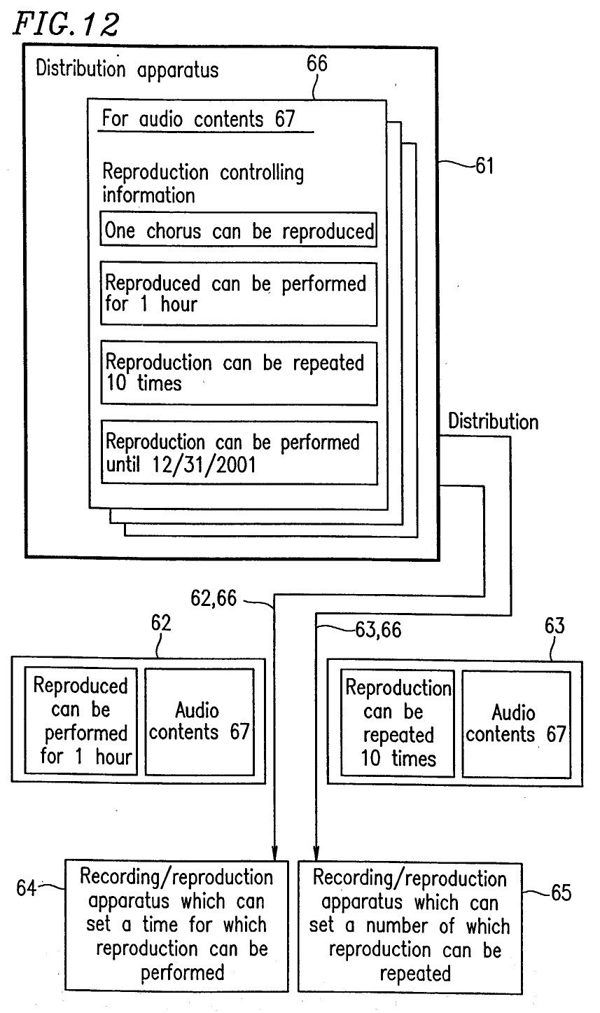

FIG. 12 shows a distribution apparatus 61 according to Example 5 of the present invention. The distribution apparatus 61 outputs presentation information 66 presenting a plurality of pieces of reproduction controlling information, which can be added to the same audio contents, to a recording/reproduction apparatus possessed by the user. The presentation information 66 is displayed on a displaying section included in the recording/reproduction apparatus. When downloading audio contents, the user selects, as reproduction controlling information contained in audio information, at least one piece of reproduction controlling information which can be set in a recording/reproduction apparatus and a reproduction apparatus possessed by the user from a plurality of pieces of reproduction controlling information indicated by the presentation information 66. The distribution apparatus 61 incorporates the reproduction controlling information selected by the user into audio information and distributes the audio information.

For example, when a user wants to download audio contents 67 to a recording/reproduction apparatus 64 which can set time during which reproduction can be performed, the user selects reproduction controlling information indicating one hour for which reproduction can be performed and downloads audio information 62 containing audio contents 67. On the other hand, when another user wants to download the audio contents 67 onto a recording/reproduction apparatus 65 which can set a number of times reproduction can be repeated, the user selects reproduction controlling information indicating that reproduction can be repeated 10 times and downloads audio information 63 containing the audio contents 67.

Note that the bill for distributed audio information may be changed depending on reproduction controlling information selected by the user. For example, audio information can be download with a less expensive bill when both an expiration date after which reproduction cannot be performed and a number of times reproduction can be repeated are contained in the audio information (reproduction controlling information) than when only the expiration date after which reproduction cannot be performed is contained in the audio information (reproduction controlling information). In other words, it is possible to provide a system in which the user can purchase audio information less expensively when more strict reproduction controlling information is selected and audio information is downloaded.

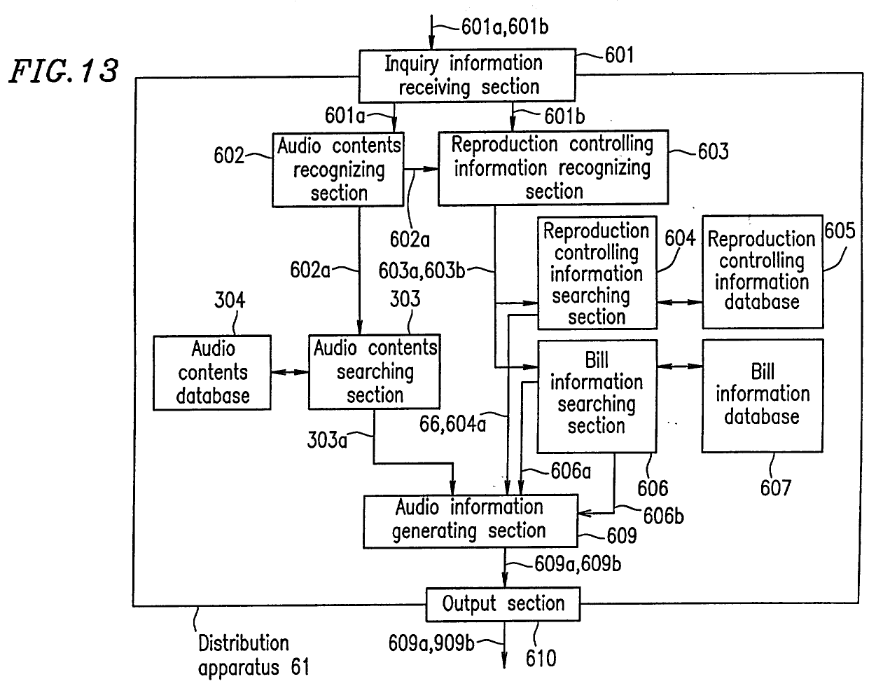

Operation of the distribution apparatus 61 will be further described with reference to FIG. 13. The distribution apparatus 61 comprises an inquiry information receiving section 601, an audio contents recognizing section 602, an audio contents searching section 303, an audio contents database 304, a reproduction controlling information recognizing section 603, a reproduction controlling information searching section 604, a reproduction controlling information database 605, a bill information searching section 606, a bill information database 607, an audio information generating section 609, and an output section 610.

The reproduction controlling information database 605 stores information for identifying reproduction controlling information and the reproduction controlling information in a pair. The reproduction controlling information identifying information is any information which can uniquely specify reproduction controlling information in the distribution apparatus 61, including, for example, serial numbers assigned to pieces of reproduction controlling information so that the same number is not assigned to different pieces of reproduction controlling information.

Note that the bill information database 607 stores reproduction controlling information identifying information and bill information indicating the bill imposed on the reproduction controlling information in a pair. The bill information also indicates the bill imposed on a combination of a plurality of pieces of reproduction controlling information. As described above, the bill varies depending on the combination of pieces of reproduction controlling information.

The reproduction controlling information recognizing section 603 stores a number for identifying audio contents and information for identifying reproduction controlling information which can be given to the audio contents in a pair.

When receiving inquiry information 601a from the user indicating that the user wants to download certain audio contents, the inquiry information receiving section 601 outputs the inquiry information 601a to the audio contents recognizing section 602. The audio contents recognizing section 602 specifies identification information 602a for audio contents to be distributed based on the inquiry information 601a, and outputs the identification information 602a to the reproduction controlling information recognizing section 603 and the audio contents searching section 303.

The reproduction controlling information recognizing section 603 specifies reproduction controlling information identifying information 603a corresponding to the identification information 602a, and outputs the reproduction controlling information identifying information 603a to the reproduction controlling information searching section 604 and the bill information searching section 606.

The reproduction controlling information searching section 604 searches the reproduction controlling information database 605 for a plurality of pieces of reproduction controlling information, which can be given to audio contents to be distributed, based on the reproduction controlling information identifying information 603a and generates and outputs the presentation information 66 to the audio information generating section 609. The bill information searching section 606 searches the bill information database 607 for bill information 606a based on the reproduction controlling information identifying information 603a and outputs the bill information 606a to the audio information generating section 609.

The audio information generating section 609 generates audio information 609a containing the presentation information 66 and the bill information 606a and outputs the audio information 609a to the output section 610 which in turn distributes the audio information 609a.

A displaying section of the user's recording/reproduction apparatus which receives the audio information 609a displays the presentation information 66 and the bill information 606a. When the user selects at least one piece of reproduction controlling information from the presentation information 66, the user's recording/reproduction apparatus returns selection result information 601b indicating a result of the selection to the distribution apparatus 61.

When receiving the selection result information 601b, the inquiry information receiving section 601 outputs the selection result information 601b to the reproduction controlling information recognizing section 603. The reproduction controlling information recognizing section 603 specifies reproduction controlling information identifying information 603b corresponding to reproduction controlling information contained in the selection result information 601b, and outputs the reproduction controlling information identifying information 603b to the reproduction controlling information searching section 604 and the bill information searching section 606. In this case, the audio contents searching section 303 searches the audio contents database 304 for audio contents 303a to be distributed based on the identification information 602a, and outputs the audio contents 303a to the audio information generating section 609.

The reproduction controlling information searching section 604 outputs reproduction controlling information 604a selected based on the reproduction controlling information identifying information 603b to the audio information generating section 609. The bill information searching section 606 output bill information 606b selected based on the reproduction controlling information identifying information 603b to the audio information generating section 609. The audio information generating section 609 generates audio information 609b containing the reproduction controlling information 604a, the bill information 606b and the audio contents 303a so that the audio information 609b complies with a format of distribution, and outputs the audio information 609b to the output section 610 which in turn distributes the audio information 609b.

Note that audio information may be substituted for video information, and audio contents may be substituted for moving images.

According to the recording/reproduction apparatus of the present invention, by converting reproduction controlling information contained in audio information into reproduction controlling information which can be set upon reproduction of audio contents, it is possible to reproduce audio information containing reproduction controlling information which cannot be set upon reproduction.

As a result, even when reproduction controlling information contained in audio information wanted by the user cannot be set upon reproduction of a recording/reproduction apparatus and a reproduction apparatus possessed by the user, it is possible to avoid a problem that audio contents cannot be reproduced.

Further, even if distribution of audio information containing new reproduction controlling information is started in the future, the recording/reproduction apparatus of the present invention can reproduce audio contents of the audio information containing new reproduction controlling information since the apparatus can receive conversion information containing a new conversion method.

Therefore, the user does not have to purchase a new recording/reproduction apparatus which is compatible with new reproduction controlling information.

Further, the recording/reproduction apparatus of the present invention can store types of reproduction controlling information which can be set by all recording/reproduction apparatuses and reproduction apparatuses possessed by the user in a memory section of the recording/reproduction apparatus, and convert reproduction controlling information contained in distributed audio information to the type of reproduction controlling information stored in the memory section.

As a result, audio information recorded onto a recording medium using the recording/reproduction apparatus of the present invention can be reproduced by any recording/reproduction apparatus and reproduction apparatus possessed by the user.

Further, the recording/reproduction apparatus of the present invention can upload data for converting new reproduction controlling information to other reproduction controlling information. After the uploading, the apparatus becomes capable of converting the new reproduction controlling information, and can deal with audio information which cannot be judged to be able to be reproduced or not. Therefore, a more number of types of audio information can be reproduced.

Furthermore, the recording/reproduction apparatus of the present invention can record audio information which is distributed to a recording medium which is permitted by a music provider. As a result, it is possible to prevent the user from illegally copying audio information or reproducing with disregard of reproduction controlling information.

Still furthermore, the distribution apparatus of the present invention incorporates conversion information relating to reproduction controlling information to audio information and distributes the audio information. Therefore, even when reproduction controlling information contained in audio information cannot be set upon reproduction, conversion information can be used to convert reproduction controlling information and record audio information, thereby making it possible to reproduce audio contents.

Therefore, audio information containing reproduction controlling information which cannot be set upon reproduction can be reproduced, whereby the user can listen to a greater number of pieces of audio information.

The distribution apparatus of the present invention incorporates information for designating a recording medium onto which audio information is to be recorded into the audio information and distributes the audio information. Therefore, the user can record data only onto a recording medium which is permitted by a music provider. For this reason, it is possible to prevent audio information distributed to a recording medium which is not permitted by a music provider from being unjustly recorded onto the recording medium or reproduced with disregard of reproduction controlling information.

The distribution apparatus of the present invention can select reproduction controlling information of audio contents which the user wants to download, thereby making it possible to select reproduction controlling information which can be set in a recording/reproduction apparatus and a reproduction apparatus possessed by the user upon reproduction and download audio information. As a result, it is possible to avoid the problem that when audio information which the user wants to listen to contains reproduction controlling information which cannot be set, audio contents cannot be reproduced.

Further, the distribution apparatus of the present invention can change depending on reproduction controlling information selected by the user, thereby making is possible to provide a system in which the user can purchase audio information less expensively.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A recording/reproduction apparatus, comprising:
a reading section for reading out audio contents and reproduction controlling information for controlling the audio contents from audio information containing the audio contents and the reproduction controlling information;
a converting section for judging whether or not the reproduction controlling information can be set upon reproduction of the audio contents, wherein when the reproduction controlling information can be set, the converting section outputs the reproduction controlling information, while when the reproduction controlling information cannot be set, the converting section converts the reproduction controlling information to other reproduction controlling information which can be set and outputs the other reproduction controlling information; and
a recording section for recording the audio contents and the reproduction controlling information onto the recording medium when the converting section outputs the reproduction controlling information, or recording the audio contents and the other reproduction controlling information onto the recording medium when the converting section outputs the other reproduction controlling information.

2. A recording/reproduction apparatus according to claim 1, wherein the converting section judges whether or not the reproduction controlling information can be set upon reproduction of the audio contents based on type information indicating a type of the reproduction controlling information which can be set.

3. A recording/reproduction apparatus according to claim 1, wherein the audio information further contains conversion permission information indicating whether or not the reproduction controlling information is permitted to be converted to the other reproduction controlling information;
the reading section further reads out the conversion permission information from the audio information;
the recording/reproduction apparatus further comprises a judging section for judging based on the conversion permission information whether or not the reproduction controlling information can be converted to the other reproduction controlling information; and
the converting section converts the reproduction controlling information to the other reproduction controlling information when the judging section judges that conversion is possible and does not convert the reproduction controlling information to the other reproduction controlling information when the judging section judges that conversion is impossible.

4. A recording/reproduction apparatus according to claim 1, wherein the audio information further contains conversion information for controlling conversion of the reproduction controlling information to the other reproduction controlling information;
the reading section further reads out the conversion information from the audio information; and
the converting section converts the reproduction controlling information to the other reproduction controlling information based on the conversion information.

5. A recording/reproduction apparatus according to claim 4, wherein the conversion information contains type information indicating a type of reproduction controlling information which can be set.

6. A recording/reproduction apparatus according to claim 5, wherein the conversion information further contains designation information designating contents of the type information.

7. A recording method, comprising:
a first step of reading out audio contents and reproduction controlling information for controlling the audio contents from audio information containing the audio contents and the reproduction controlling information;
a second step of judging whether or not the reproduction controlling information can be set upon reproduction of the audio contents, wherein when the reproduction controlling information can be set, the reproduction controlling information is output, while when the reproduction controlling information cannot be set, the reproduction controlling information is converted to other reproduction controlling information which can be set and the other reproduction controlling information is output; and
a third step of recording the audio contents and the reproduction controlling information onto the recording medium when the reproduction controlling information is output in the second step, or recording the audio contents and the other reproduction controlling information onto the recording medium when the other reproduction controlling information is output in the second step.

8. A distribution apparatus, comprising:
a database storing a plurality of audio contents; and
an output section for outputting audio information containing at least one of the plurality of audio contents,
wherein the audio information further contains reproduction controlling information for controlling the at least one of the plurality of audio contents, and conversion permission information indicating whether or not the reproduction controlling information is permitted to be converted to other reproduction controlling information.

9. A distribution apparatus, comprising:
a database storing a plurality of audio contents; and
an output section for outputting audio information containing at least one of the plurality of audio contents,
wherein the audio information further contains reproduction controlling information for controlling the at least one of the plurality of audio contents, and conversion information for controlling conversion of the reproduction controlling information to other reproduction controlling information.

10. A distribution apparatus according to claim 9, wherein the conversion information contains type information indicating a type of reproduction controlling information which can be set.

11. A distribution apparatus according to claim 10, wherein the conversion information further contains designation information designating contents of the type information.

12. A reproduction apparatus, comprising:
a reading section for reading out audio contents and reproduction controlling information for controlling the audio contents from audio information containing the audio contents and the reproduction controlling information;
a judging section for judging whether or not the audio contents can be reproduced; and
a reproduction section for reproducing the audio contents when a result of judgment by the judging section indicates that reproduction is possible, or not reproducing the audio contents when a result of judgment by the judging section indicates that reproduction is impossible,
wherein the judging section judges whether or not the reproduction controlling information can be set upon reproduction of the audio contents;
when the reproduction controlling information can be set, the judging section judges whether or not the audio contents can be reproduced based on the reproduction controlling information; and
when the reproduction controlling information cannot be set, the judging section converts the reproduction controlling information to other reproduction controlling information which can be set, and judges whether or not the audio contents can be reproduced based on the other reproduction controlling information.

13. A reproduction apparatus according to claim 12, wherein the judging section converts the reproduction controlling information to the other reproduction controlling information based on conversion information for controlling conversion of the reproduction controlling information to the other reproduction controlling information.

14. A recording/reproduction apparatus, comprising:
a reading section for reading out audio contents and permission information indicating a recording medium onto which the audio contents are permitted to be recorded, from audio information containing the audio contents and the permission information;
a judging section for judging whether or not the audio contents can be recorded onto a recording medium based on the permission information; and
a recording section for recording the audio contents onto the recording medium when the judging section judges that recording is possible, and not recording the audio contents onto the recording medium when the judging section judges that recording is impossible.

15. A distribution apparatus, comprising:
a database storing a plurality of audio contents; and
an output section for outputting audio information containing at least one of the plurality of audio contents,
wherein the audio information further contains permission information indicating a recording medium onto which the at least one of the plurality of audio contents is permitted to be recorded.

16. A distribution apparatus, comprising:
a database storing a plurality of audio contents; and
an output section for outputting a plurality of types of reproduction controlling information for controlling at least one of the plurality of audio contents,
wherein the output section outputs audio information containing the at least one of the plurality of audio contents and at least one piece of the plurality of types of reproduction controlling information selected by the user.

17. A distribution apparatus according to claim 16, wherein a bill for the audio information output by the output section is changed based on the at least one reproduction controlling information selected by the user.
